(19) United States
(12) Patent Application Publication
(10) Pub. No.: US 2026/0214681 A1
(43) Pub. Date: Jul. 23, 2026

(54) METHOD AND APPARATUS FOR HANDLING SIDELINK DURING L1L2 BASED MOBILITY IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Hyunjeong KANG, Suwon-si (KR)

(21) Appl. No.: 19/137,238

(22) PCT Filed: Dec. 27, 2023
(86) PCT No.: PCT/KR2023/021721

§ 371 Date: Jun. 9, 2025

(30) Foreign Application Priority Data
Jan. 4, 2023 (KR) 10-2023-0001337

(51) Int. Cl. H04W 72/25; H04W 28/02

(52) U.S. Cl. CPC H04W 72/25; H04W 28/0278

(57) ABSTRACT

The present disclosure provides a method performed by a terminal comprising: receiving, from a source base station (BS), a first message including configuration information for a candidate target BS; transmitting, to the source BS, a second message including an LI measurement report for the candidate target BS; receiving, from the source BS, a cell switch command to the candidate target BS; and identifying whether a partial reset for a sidelink communication is indicated in the configuration information for the candidate target BS.

### TECHNICAL FIELD

The disclosure relates to a wireless communication system (or a mobile communication system). Specifically, the disclosure relates to an apparatus, a method and a system for handling sidelink during L1L2 based mobility in wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Recently, there are needs to enhance sidelink communication with respect to development of L1L2 based mobility.

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a source base station, a first message including configuration information for a candidate target base station; transmitting, to the source base station, a second message including an L1 measurement report for the candidate target base station; receiving, from the source base station, a cell switch command to the candidate target base station; and identifying whether a partial reset for a sidelink communication is indicated in the configuration information for the candidate target base station.

In accordance with another aspect of the disclosure, a terminal is provided. The terminal comprises: a transceiver; and a controller coupled with the transceiver and configured to: receive, from a source base station, a first message including configuration information for a candidate target base station, transmit, to the source base station, a second message including an L1 measurement report for the candidate target base station, receive, from the source base station, a cell switch command to the candidate target base station, and identify whether a partial reset for a sidelink communication is indicated in the configuration information for the candidate target base station.

### Advantageous Effects of Invention

According to various embodiments of the disclosure, handling of sidelink can be efficiently enhanced with regard to L1L2 mobility.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example of handover procedure in accordance with an embodiment of the disclosure.

FIG. 2 illustrates another example of lower layer based mobility procedure in accordance with an embodiment of the disclosure.

FIG. 3 illustrates another example of lower layer based mobility procedure in accordance with an embodiment of the disclosure.

FIG. 4 is a block diagram of a terminal according to an embodiment of the disclosure.

FIG. 5 is a block diagram of a base station according to an embodiment of the disclosure.

Throughout the drawings, like reference numerals will be understood to refer to like parts, components, and structures.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as RX beam.

The fifth generation wireless communication system, supports standalone mode of operation as well dual connectivity (DC). In DC a multiple Rx/Tx UE may be configured to utilize resources provided by two different nodes (or base stations) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in a radio resource control connected (RRC_CONNECTED) is configured to utilize radio resources provided by two distinct schedulers, located in two different nodes connected via a non-ideal backhaul and providing either Evolved Universal Mobile Telecommunications System (UMTS) Terrestrial Radio Access (E-UTRA) (i.e., if the node is an ng-eNB) or NR access (i.e., if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the primary cell (PCell) and optionally one or more secondary cells (SCells). In NR the term Secondary Cell Group (SCG) refers to a group of serving cells associated with the Secondary Node, comprising of the primary SCG cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell (SpCell). PSCell refers to a serving cell in SCG in which the UE performs random access when performing the Reconfiguration with Sync procedure. For Dual Connectivity operation the term SpCell refers to the PCell of the MCG or the PSCell of the SCG, otherwise the term Special Cell refers to the PCell.

PDCCH in fifth generation wireless communication system: In the fifth generation wireless communication system, Physical Downlink Control Channel (PDCCH) is used to schedule downlink (DL) transmissions on physical downlink shared channel (PDSCH) and uplink (UL) transmissions on physical uplink shared channel (PUSCH), where the Downlink Control Information (DCI) on PDCCH includes: Downlink as-signments containing at least modulation and coding format, resource allocation, and hybrid-automatic repeat request (ARQ) information related to downlink shared channel (DL-SCH); Uplink scheduling grants containing at least modulation and coding format, resource allocation, and hybrid-ARQ information related to uplink shared channel (UL-SCH). In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the physical resource block(s) (PRB(s)) and orthogonal frequency division multiplexing (OFDM) symbol(s) where the UE may assume no transmission is intended for the UE; Transmission of transmission power control (TPC) commands for physical uplink control channel (PUCCH) and PUSCH; Transmission of one or more TPC commands for sounding reference signal (SRS) transmissions by one or more UEs; Switching a UE's active bandwidth part; Initiating a random access procedure. A UE monitors a set of PDCCH candidates in the configured monitoring occasions in one or more configured Control REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

Bandwidth adaptation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by con-figuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve UL time synchronization. RA is used during initial access, handover, RRC connection re-establishment procedure, scheduling request transmission, SCG addition/modification, beam failure recovery and data or control information transmission in UL by non-synchronized UE in RRC CONNECTED state. Several types of random access procedure is supported.

Contention based random access (CBRA): This is also referred as 4 step CBRA. In this type of random access, UE first transmits Random Access preamble (also referred as Msg1) and then waits for Random access response (RAR) in the RAR window. RAR is also referred as Msg2. Next generation node B (gNB) transmits the RAR on PDSCH. PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first OFDM symbol of the PRACH occasion where UE has transmitted Msg1, i.e. RA preamble; 0≤s_id<14 ; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random access preambles detected by gNB can be multiplexed in the same RAR medium access control (MAC) protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step i.e. select random access resource (preamble/RACH occasion) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, system information (SI) request etc. It may include the UE identity (i.e. cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a PDCCH addressed to C-RNTI included in Msg3, contention resolution is considered successful, contention resolution timer is stopped and RA procedure is completed. While the contention resolution timer is running, if UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step i.e. select random access resource (preamble/RACH occasion) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for SCell, etc. Evolved node B (eNB) assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to CBRA procedure. CFRA is considered successfully completed after receiving the RAR including RAPID of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e. during random access resource selection for Msg1 transmission UE determines whether to transmit dedicated preamble or non dedicated preamble. Dedicated preambles are typically provided for a subset of synchronization signal and physical broadcast channel blocks (SSBs)/channel state information reference signals (CSI-RSs). If there is no SSB/CSI-RS having DL reference signal received power (RSRP) above a threshold amongst the SSBs/CSI-RSs for which contention free random access resources (i.e., dedicated preambles/ROs) are provided by gNB, UE select non dedicated preamble. Otherwise, UE select dedicated preamble. So, during the RA procedure, one random access attempt can be CFRA while other random access attempt can be CBRA.

2 step contention based random access (2 step CBRA): In the first step, UE transmits random access preamble on PRACH and a payload (i.e., MAC PDU) on PUSCH. The random access preamble and payload transmission is also referred as MsgA. In the second step, after MsgA transmission, the UE monitors for a response from the network (i.e., gNB) within a configured window. The response is also referred as MsgB. gNB transmits the MsgB on PDSCH. PDCCH scheduling the PDSCH carrying MsgB is addressed to MsgB-radio network temporary identifier (MSGB-RNTI). MSGB-RNTI identifies the time-frequency resource (also referred as PRACH occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg 1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If CCCH SDU was transmitted in MsgA payload, UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e., upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the MsgA configurable number of times, UE fallbacks to 4 step RACH procedure (i.e., UE only transmits the PRACH preamble).

MsgA payload may include one or more of CCCH SDU, dedicated control channel (DCCH) SDU, dedicated traffic channel (DTCH) SDU, buffer status report (BSR) MAC CE, power headroom report (PHR) MAC CE, SSB information, C-RNTI MAC CE, or padding. MsgA may include UE ID (e.g. random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g. in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g. one or more DL TX beam ID(s) or SSB ID(s)), beam failure recovery indication/information, data indicator, cell/BS/transmission and reception point (TRP) switching indication, connection re-establishment indication, reconfiguration complete or handover complete message, etc.

2 step contention free random access (2 step CFRA): In this case gNB assigns to UE dedicated Random access preamble(s) and PUSCH resource(s) for MsgA transmission. RO(s) to be used for preamble transmission may also be indicated. In the first step, UE transmits random access preamble on PRACH and a payload on PUSCH using the contention free random access resources (i.e. dedicated preamble/PUSCH resource/RO). In the second step, after MsgA transmission, the UE monitors for a response from the network (i.e. gNB) within a configured window. The response is also referred as MsgB.

GNB transmits the MsgB on PDSCH. PDCCH scheduling the PDSCH carrying MsgB is addressed to MSGB-RNTI. MSGB-RNTI identifies the time-frequency resource (also referred as PRACH occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first OFDM symbol of the PRACH occasion where UE has transmitted Msg 1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for NUL carrier and 1 for SUL carrier.

If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access i.e. during random access resource selection for MsgA transmission UE determines whether to transmit dedicated preamble or non dedicated preamble. Dedicated preambles are typically provided for a subset of SSBs/CSI RSs. If there is no SSB/CSI RS having DL RSRP above a threshold amongst the SSBs/CSI RSs for which contention free random access resources (i.e. dedicated preambles/ROs/PUSCH resources) are provided by gNB, UE select non dedicated preamble. Otherwise UE select dedicated preamble. So during the RA procedure, one random access attempt can be 2 step CFRA while other random access attempt can be 2 step CBRA.

Upon initiation of random access procedure, UE first selects the carrier (SUL or NUL). If the carrier to use for the Random Access procedure is explicitly signalled by gNB, UE select the signalled carrier for performing Random Access procedure. If the carrier to use for the Random Access procedure is not explicitly signalled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure as specified in section 5.15 of TS 38.321. UE then determines whether to perform 2 step or 4 step RACH for this random access procedure.

If this random access procedure is initiated by PDCCH order and if the ra-PreambleIndex explicitly provided by PDCCH is not 0b000000, UE selects 4 step RACH.
else if 2 step contention free random access resources are signaled by gNB for this random access procedure, UE selects 2 step RACH.
else if 4 step contention free random access resources are signaled by gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources,
* if RSRP of the downlink pathloss reference is below a configured threshold, UE selects 4 step RACH. Otherwise UE selects 2 step RACH.

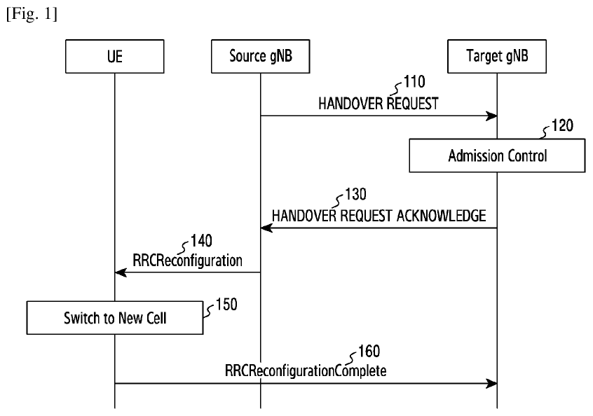

FIG. 1 illustrates an example of handover procedure in accordance with an embodiment of the disclosure.

Mobility in in fifth generation wireless communication system: There are two types of mobility, cell level mobility and beam level mobility. Cell Level Mobility requires explicit RRC signaling to be triggered, i.e. handover. For inter-gNB handover, the signaling procedures comprise at least the following procedures as shown in FIG. 1 below.

The source gNB initiates handover and issues a HANDOVER REQUEST over the Xn interface (110). The target gNB performs admission control (120) and provides the new RRC configuration as part of the HANDOVER REQUEST ACKNOWLEDGE (130). The source gNB provides the RRC configuration to the UE by forwarding the RRCReconfiguration message received in the HANDOVER REQUEST ACKNOWLEDGE (140). The RRCReconfiguration message includes at least cell ID and all information required to access the target cell so that the UE can access the target cell without reading system information. For some cases, the information required for contention-based and contention-free random access can be included in the RRCReconfiguration message. The access information to the target cell may include beam specific information, if any. The UE moves the RRC connection to the target gNB and replies with the RRCReconfigurationComplete (150, 160). Several types of handover, normal handover, conditional handover and dual active protocol stacks (DAPS) handover are supported.

Beam Level Mobility does not require explicit RRC signaling to be triggered. The gNB provides for serving cell via RRC signaling the UE with measurement configuration containing configurations of SSB/CSI-RS resources and resource sets, reports and trigger states for triggering channel and interference measurements and reports. Beam Level Mobility is then dealt with at lower layers by means of physical layer and MAC layer control signaling, and RRC is not required to know which beam is being used at a given point in time. Based on physical layer and MAC layer control signaling UE can be switched from one beam to another in serving cell.

Lower Layer Mobility: A new type of lower layer mobility also referred as L1/L2-triggered mobility (LTM) is being investigated. The Lower Layer Mobility is based on L1 measurements that are provided by the UE to the serving cell. Based on these measurements, handover is triggered by sending L1 (e.g., DCI) or L2 (e.g., MAC CE) command. In Lower Layer Mobility, the serving cell change is triggered based on L1 beam measurements instead of L3 cell power and quality measurements that are configured in NR baseline handover of Rel. 15. L3 cell quality measurements are reported only after some Time-to-Trigger (TTT) expires for a measurement event. L3 measurements also filtered based on L3 configuration over multiple measurements before reporting. L1 measurements have the benefit that the network can react faster to radio link degradation in the serving link as the network can save the delay introduced by L3 filtering and TTT for the handover decision. This should result in reducing in the number of radio link failures compared to baseline handover.

In the legacy handover, RRC procedure delay consists of RRC signal processing related to decoding of handover command and L2/3 reconfiguration of the protocol layers. For lower layer mobility, RRC procedure delay can be reduced given that the UE can receive and decode the configuration of the target cells before the cell change occurs. Moreover, since lower layer mobility is restricted to intra-CU scenario with same PDCP and RRC, L2/3 reconfigurations can be minimized by keeping the same configuration for PDCP and RRC and possibly other layers such as radio link control (RLC) and MAC in intra-DU scenario, i.e., in inter-DU scenario the new target cell may have differ configurations for RLC and MAC. In the best case for intra-DU, the target cell can reconfigure only the new C-RNTI which can save the entire L2/3 reconfiguration for the UE.

In legacy handover there is delay due to radio frequency (RF)/baseband retuning, derivation of target gNB security keys and configuration of the security algorithm to be used in the target cell. These can also be avoided in lower layer mobility. Given that the PDCP entity in the CU is the same for both source and target cells, the same security keys and algorithms can be applied which reduces the interruption time.

In the legacy handover there is interruption due to uncertainty in acquiring the first available PRACH occasion in the new cell. In addition, there are the interruptions of sending PRACH preamble and receiving the RAR. These random access related interruption components can be reduced in Lower Layer Mobility by introducing RACH-less handover where the UE skips the entire random-access procedure to the target cell. For scenarios where RACH-less cannot be applied, the UE can acquire the timing advance of the prepared target cells before the actual handover occurs.

Meanwhile, in the legacy handover procedure when handover command is received, MAC entity in the UE:
initializes SBj for each logical channel to zero if Sidelink resource allocation mode 1 is configured by RRC;
sets the new data indicators (NDIs) for all HARQ process IDs to the value 0 for monitoring PDCCH in Sidelink resource allocation mode 1;
cancel, if any, triggered Sidelink Buffer Status Reporting procedure;
cancel, if any, triggered configured sidelink grant confirmation;
reset all SL_LBT_COUNTERs.

As a result, SL HARQ retransmission is not possible upon handover and RLC level retransmission is needed. Also the buffer status report can be triggered again only when new data arrives in the buffer resulting in delay to receive UL grant. Thus, some enhancement is needed.

### Example 1

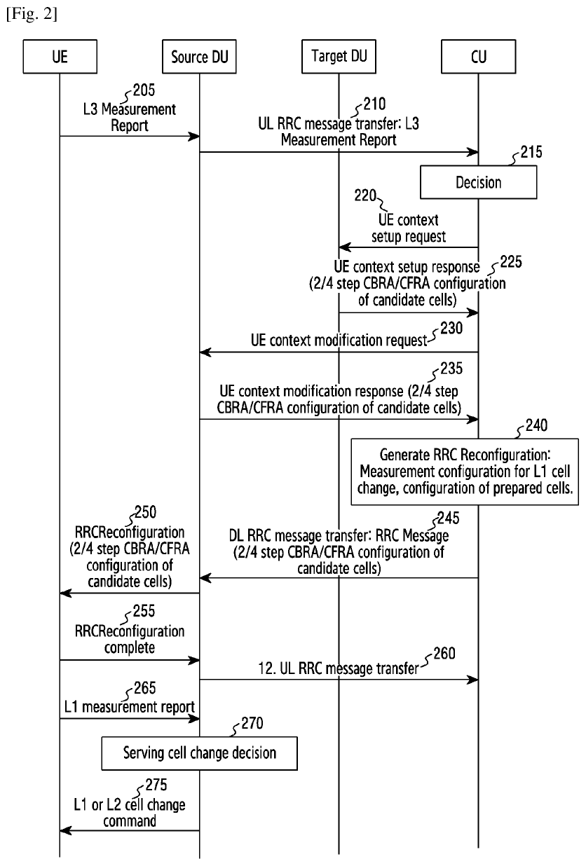

FIG. 2 and FIG. 3 illustrate examples of lower layer based mobility procedure in accordance with an embodiment of the disclosure.

UE sends/transmits a L3/L1 measurement report containing the measurements of serving and target cell(s) (205). Measurement report is sent to serving cell. Serving DU of serving cell then forwards the report to CU (210). The measurement report can be based on L3 measurements or L1 measurements.

Based on the reported measurements, the CU may identify a potential set of candidate target cells to which the UE can be handed over to (215). In this example, the CU identifies candidate target cells that are served by either source DU or another DU (i.e., target DU) which are controlled by the same CU.

The CU requests the preparation of a candidate target cell controlled by the target DU by sending UE Context Setup Request message (220). The target DU provides the configuration of the UE in UE Context Setup Response messages, respectively, containing a container from DU to CU (225). The configuration may contain UE-specific and non-UE-specific parts. Note that the operation 220 and the operation 225 are not performed if candidate target cells of other DU are not identified in operation 215.

The configuration may include 4 step RA configuration (rach-ConfigCommon) and/or 2 step RA configuration (msgA-ConfigCommon). These RA configuration of candidate target cell is BWP specific and may be included in the respective BWP configuration of that candidate target cell. Rach-ConfigCommon indicates prach-ConfigurationIndex which is used to identify the PRACH occasions in time domain. Rach-ConfigCommon indicates msg1-FDM (The number of PRACH transmission occasions frequency division multiplexed (FDMed) in one time instance) and msg1-FrequencyStart (Offset of lowest PRACH transmission occasion in frequency domain with respective to PRB 0) to identify the PRACH occasions in frequency domain. Rach-ConfigCommon also indicates at least one of other parameters, such as preambleReceivedTargetPower, preambleTransMax, powerRampingStep, ra-ResponseWindow, ra-ContentionResolutionTimer, rsrp-ThresholdSSB, rsrp-ThresholdSSBSUL, preamble group B configuration, msg1-SubcarrierSpacing, or ssb-perRACH-OccasionAndCB-PreamblesPerSSB. Rach-ConfigCommon may include RA Prioritisation parameters (powerRampingStepHighPriority and scalingFactorBI) to be applied for 4 step RA initiated towards the cell upon L1L2 cell change/switch command. MsgA-ConfigCommon includes configuration of cell-specific MsgA PUSCH parameters such as MsgA PUSCH resources (msgA-PUSCH-ResourceGroupA) that the UE shall use when performing MsgA transmission using preambles group A, A PUSCH resources (msgA-PUSCH-ResourceGroupB) that the UE shall use when performing MsgA transmission using preambles group B. MsgA-ConfigCommon indicates msgA-PRACH-ConfigurationIndex which is used to identify the PRACH occasions in time domain. MsgA-ConfigCommon indicates msgA-RO-FDM (The number of PRACH transmission occasions FDMed in one time instance) and msgA-RO-Frequency Start (Offset of lowest PRACH transmission occasion in frequency domain with respective to PRB 0) to identify the PRACH occasions in frequency domain. MsgA-ConfigCommon also indicates at least one of other parameters such as msgA-PreambleReceivedTargetPower, preambleTransMax, msgA-TransMax, msgA-PreamblePowerRampingStep, msgB-ResponseWindow, ra-ContentionResolutionTimer, msgA-RSRP-ThresholdSSB, preamble group B configuration, msgA-SubcarrierSpacing, or msgA-SSB-PerRACH-OccasionAndCB-PreamblesPerSSB. MsgA-ConfigCommon may include RA Prioritisation parameters (powerRampingStepHighPriority and scalingFactorBI) to be applied for 4 step RA initiated towards the cell upon L1L2 cell change/switch command.

The candidate target cell configuration of SpCell may include dedicated RA configuration (rach-ConfigDedicated for CFRA) for SUL and/or dedicated RA configuration (rach-ConfigDedicated) NUL to applied for RA initiated towards the cell upon L1L2 cell change/switch command indicating switching to the cell. The rach-ConfigDedicated may include RA Prioritisation parameters (powerRampingStepHighPriority and scalingFactorBI) to be applied for 4 step RA. The rach-ConfigDedicated may include RA Prioritisation parameters (powerRampingStepHighPriority and scalingFactorBI) to be applied for 2 step RA. The rach-ConfigDedicated may include at least one of 4 step RA parameters such as prach-ConfigurationIndex, msg1-FDM, msg1-FrequencyStart to identify the PRACH occasions, or other parameters such as preambleReceivedTargetPower, preambleTransMax, powerRampingStep, ra-ResponseWindow. For 4 step RA, rach-ConfigDedicated may include list of one or more {SSB index and RA preamble index to use in the RA occasions associated with this SSB} and/or list of one or more {CSI RS index, RA preamble index to use in the RA occasions associated with this CSI-RS and a list of RACH occasions for this CSI RS}. For 4 step RA, rach-ConfigDedicated may include ra-ssb-OccasionMaskIndex which indicates a subset of RACH occasions per SSB which can be used amongst the RACH occasions for 4 step RA. The rach-ConfigDedicated may include at least one of 2 step RA parameters such as msgA-PRACH-ConfigurationIndex, msgA-RO-FDM, msgA-RO-FrequencyStart to identify the PRACH occasions, or other parameters such as msgA-PreambleReceivedTargetPower, preambleTransMax, powerRampingStep, msgB-Response Window. For 2 step RA, rach-ConfigDedicated may include MsgA PUSCH resources (msgA-CFRA-PUSCH) that the UE shall use when performing MsgA transmission for CFRA. For 2 step RA, rach-ConfigDedicated may include list of one or more {SSB index, RA preamble index to use in the RA occasions associated with this SSB, PUSCH resource index (msgA-PUSCH-Resource-Index) of PUSCH resource to be used for this SSB } and/or list of one or more {CSI RS index, RA preamble index and PUSCH resource index (msgA-PUSCH-Resource-Index) of PUSCH resource to be used for this SSB}. The PUSCH resource index indicates a valid PUSCH occasion and the associated DMRS resources corresponding to a PRACH slot. The PUSCH resource indexes are sequentially numbered and are mapped to valid PUSCH occasions corresponding to a PRACH slot which are ordered, first, in increasing order of frequency resource indexes for frequency multiplexed PUSCH occasions; second, in increasing order of DMRS resource indexes within a PUSCH occasion, where a DMRS resource index DMRSID is determined first in an ascending order of a DMRS port index and then in an ascending order of a DMRS sequence index, third in increasing order of time resource indexes for time multiplexed PUSCH occasions within a PUSCH slot and fourth, in increasing order of indexes for PUSCH slots. For the case of contention free 2-step random access type, if this field is absent, the UE shall use the value 0. For 2 step RA, rach-ConfigDedicated may include ra-ssb-OccasionMaskIndex which indicates a subset of RACH occasions per SSB which can be used amongst the RACH occasions for 2 step RA. The rach-ConfigDedicated may include PUSCH resource configuration(s) for msgA CFRA, msgA-TransMax (Max number of MsgA preamble transmissions performed before switching to 4-step type random access).

The CU requests the preparation of a candidate target cell controlled by the source DU by sending UE Context Modification Request message (230). The source DU provides the configuration of the UE in UE Context Modification Response message containing a container from DU to CU (235). The configuration may contain UE-specific and non-UE-specific parts. Note that the operation 230 and the operation 235 are not performed if candidate target cells of source DU are not identified in operation 215.

-The configuration may include 4 step RA configuration (rach-ConfigCommon) and/or 2 step RA configuration (msgA-ConfigCommon). These RA configurations of candidate target cell are BWP specific and may be included in the respective BWP configuration of that candidate target cell. Rach-ConfigCommon indicates prach-ConfigurationIndex which is used to identify the PRACH occasions in time domain. Rach-ConfigCommon indicates msg1-FDM (The number of PRACH transmission occasions FDMed in one time instance) and msg1-FrequencyStart (Offset of lowest PRACH transmission occasion in frequency domain with respective to PRB 0) to identify the PRACH occasions in frequency domain. Rach-ConfigCommon also indicates at least one of other parameters such as preambleReceivedTargetPower, preambleTransMax, powerRampingStep, ra-ResponseWindow, ra-ContentionResolutionTimer, rsrp-ThresholdSSB, rsrp-ThresholdSSBSUL, preamble group B configuration, msg1-SubcarrierSpacing, or ssb-perRACH-OccasionAndCB-PreamblesPerSSB. Rach-ConfigCommon may include RA Prioritisation parameters (powerRampingStepHighPriority and scalingFactorBI) to be applied for 4 step RA initiated towards the cell upon L1L2 cell change/switch command. MsgA-ConfigCommon includes configuration of cell-specific MsgA PUSCH parameters such as MsgA PUSCH resources (msgA-PUSCH-ResourceGroupA) that the UE shall use when performing MsgA transmission using preambles group A, A PUSCH resources (msgA-PUSCH-ResourceGroupB) that the UE shall use when performing MsgA transmission using preambles group B. msgA-ConfigCommon indicates msgA-PRACH-ConfigurationIndex which is used to identify the PRACH occasions in time domain. MsgA-ConfigCommon indicates msgA-RO-FDM (The number of PRACH transmission occasions FDMed in one time instance) and msgA-RO-FrequencyStart (Offset of lowest PRACH transmission occasion in frequency domain with respective to PRB 0) to identify the PRACH occasions in frequency domain. MsgA-ConfigCommon also indicates at least one of other parameters such as msgA-PreambleReceivedTargetPower, preambleTransMax, msgA-TransMax, msgA-PreamblePowerRampingStep, msgB-ResponseWindow, ra-ContentionResolutionTimer, msgA-RSRP-ThresholdSSB, preamble group B configuration, msgA-SubcarrierSpacing, or msgA-SSB-PerRACH-OccasionAndCB-PreamblesPerSSB. MsgA-ConfigCommon may include RA Prioritisation parameters (powerRampingStepHighPriority and scalingFactorBI) to be applied for 4 step RA initiated towards the cell upon L1L2 cell change/switch command.

The candidate target cell configuration of SpCell may include dedicated RA configuration (rach-ConfigDedicated for CFRA) for SUL and/or dedicated RA configuration (rach-ConfigDedicated) NUL to applied for RA initiated towards the cell upon L1L2 cell change/switch command indicating switching to the cell. The rach-ConfigDedicated may include RA Prioritisation parameters (powerRampingStepHighPriority and scalingFactorBI) to be applied for 4 step RA. The rach-ConfigDedicated may include RA Prioritisation parameters (powerRampingStepHighPriority and scalingFactorBI) to be applied for 2 step RA. The rach-ConfigDedicated may include at least one of 4 step RA parameters such as prach-ConfigurationIndex, msg1-FDM, msg1-FrequencyStart to identify the PRACH occasions, or other parameters such as preambleReceivedTargetPower, preambleTransMax, powerRampingStep, ra-ResponseWindow. For 4 step RA, rach-ConfigDedicated may include list of one or more {SSB index and RA preamble index to use in the RA occasions associated with this SSB} and/or list of one or more {CSI RS index, RA preamble index to use in the RA occasions associated with this CSI-RS and a list of RACH occasions for this CSI RS}. For 4 step RA, rach-ConfigDedicated may include ra-ssb-OccasionMaskIndex which indicates a subset of RACH occasions per SSB which can be used amongst the RACH occasions for 4 step RA. The rach-ConfigDedicated may include at least one of 2 step RA parameters such as msgA-PRACH-ConfigurationIndex, msgA-RO-FDM, msgA-RO-FrequencyStart to identify the PRACH occasions, or other parameters such as msgA-PreambleReceivedTargetPower, preambleTransMax, powerRampingStep, msgB-Response Window. For 2 step RA, rach-ConfigDedicated may include MsgA PUSCH resources (msgA-CFRA-PUSCH) that the UE shall use when performing MsgA transmission for CFRA. For 2 step RA, rach-ConfigDedicated may include list of one or more {SSB index, RA preamble index to use in the RA occasions associated with this SSB, PUSCH resource index (msgA-PUSCH-Resource-Index) of PUSCH resource to be used for this SSB} and/or list of one or more {CSI RS index, RA preamble index and PUSCH resource index (msgA-PUSCH-Resource-Index) of PUSCH resource to be used for this SSB}. The PUSCH resource index indicates a valid PUSCH occasion and the associated DMRS resources corresponding to a PRACH slot. The PUSCH resource indexes are sequentially numbered and are mapped to valid PUSCH occasions corresponding to a PRACH slot which are ordered, first, in increasing order of frequency resource indexes for frequency multiplexed PUSCH occasions; second, in increasing order of DMRS resource indexes within a PUSCH occasion, where a DMRS resource index DMRSID is determined first in an ascending order of a DMRS port index and then in an ascending order of a DMRS sequence index, third in increasing order of time resource indexes for time multiplexed PUSCH occasions within a PUSCH slot and fourth, in increasing order of indexes for PUSCH slots. For the case of contention free 2-step random access type, if this field is absent, the UE shall use the value 0. For 2 step RA, rach-ConfigDedicated may include ra-ssb-OccasionMaskIndex which indicates a subset of RACH occasions per SSB which can be used amongst the RACH occasions for 2 step RA. The rach-ConfigDedicated may include PUSCH resource configuration(s) for msgA CFRA, msgA-TransMax (Max number of MsgA preamble transmissions performed before switching to 4-step type random access).

Upon receiving the UE configurations for the candidate target cell(s), the CU generates an RRC Reconfiguration (240) including the configuration of candidate target cell(s) that is sent to the UE (245, 250). The RRC Reconfiguration may include separate RRC Reconfiguration IE for each of candidate target cell(s) of Cell-GroupConfig UE for each of candidate target cell(s). CU sends the configuration to source DU which then sends it to the UE. Among other information, the RRC Reconfiguration message contains: Measurement reporting configuration for L1/L2 mobility, i.e., configuration on how to report the L1 beam measurements of serving and target cells. ; Configuration of the prepared candidate cell(s) which the UE needs to execute when it receives a L1/L2 command to change the serving cell, such as random access configuration as described earlier, radio bearer configurations, indication of whether to perform PDCP re-establishment or not (per data radio bearer (DRB) or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, whether to perform partial reset for SL or not etc. In an embodiment, these indications (indication of whether to perform PDCP re-establishment or not (per DRB or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, whether to perform partial reset for SL or not etc.) for a candidate target cell can be provided separately with respect to several cells e.g. each of other candidate target cell and source cell. For example, let's say there are three cells Cell A, Cell B and Cell C. For Cell A, these indications can be signalled separately for Cell B and separately for Cell C. Upon receiving L1 or L2 cell change/switch command (MAC CE or DCI) to switch to Cell A when current serving Cell is Cell B, UE applies the indications signalled for Cell A corresponding to Cell B. Upon receiving L1 or L2 cell change/switch command (MAC CE or DCI) to switch to Cell A when current serving Cell is Cell C, UE applies the indications signalled for Cell A corresponding to Cell C. In an embodiment, multiple sets of these indications (indication of whether to perform PDCP re-establishment or not (per DRB or common for all), indication of whether to perform PDCP level data recovery or not (per DRB or common for all), indication of whether to perform RLC re-establishment or not (per DRB or RLC channel or common for all), indication of whether to perform MAC reset or partial MAC reset or not, whether to perform partial reset for SL or not etc.) for a candidate target cell can be provided. The applicable cells for each of these set is also indicated. If UE handovers/switches to a target cell A from source cell B, UE applies the set of indications in target cell configuration corresponding to cell B. RRC Reconfiguration may also include firstActive-UplinkBWP and firstActiveDownlinkBWP for each prepared candidate cell(s) and list of DL and UL BWP configurations for each prepared candidate cell(s). RRC Reconfiguration may also include InitialUplinkBWP and InitialDownlinkBWP for each prepared candidate cell(s) and list of DL and UL BWP configurations for each prepared candidate cell(s).

The UE confirms a completion of the RRC Reconfiguration to the network (255, 260).

After confirming the RRC Reconfiguration to the network, the UE starts to report the L1 beam measurement of serving and candidate target cells (265). Based on measurements serving cell may decide to trigger cell change command (270). In an example, upon determining that there is a target candidate cell having a better radio link/beam measurement than the serving cell (270), e.g., L1-RSRP of target beam measurement >L1-RSRP of serving beam measurement+Offset for a time period (i.e. Time-to-Trigger (TTT) period), the serving cell sends a L1 or L2 cell change/switch command (275) to trigger the cell change to the target candidate cell. It is to be noted that RRCReconfiguration may also be sent based on the measurements received (265) and later when condition for cell change is met, serving cell sends a L1 or L2 cell change/switch command.

Upon receiving the L1 or L2 cell change/switch command (MAC CE or DCI) for a target cell (SpCell), UE perform the following operation:
If partial reset for sidelink (or sidelink communication) is indicated (or in other words full reset for sidelink is not indicated or full reset for sidelink is set to false) in the operation 205 and the operation 210 for target cell (e.g. in target cell configuration corresponding to cell from which UE is switching to this target cell) (and sidelink com-munication configuration is included in target cell configuration):
   Do not set the NDIs for all HARQ process IDs to the value 0 for monitoring PDCCH in Sidelink resource allocation mode 1
   Do not cancel, if any, triggered Sidelink Buffer Status Reporting procedure;
   Do not initialize SBj for each logical channel to zero if Sidelink resource allocation mode 1 is configured by RRC;
Else:
   sets the NDIs for all HARQ process IDs to the value 0 for monitoring PDCCH in Sidelink resource allocation mode 1
   cancel, if any, triggered Sidelink Buffer Status Reporting procedure;
   initialize SBj for each logical channel to zero if Sidelink resource allocation mode 1 is configured by RRC;
cancel, if any, triggered configured sidelink grant confirmation
reset all SL_LBT_COUNTERs.

### Example 2

(Alternate) Upon receiving the L1 or L2 cell change/switch command (MAC CE or DCI) for a target cell (SpCell), UE perform the following operation:
If partial MAC reset is indicated (or in other words full reset for MAC is not indicated or full reset for MAC is set to false) in the operation 205 and the operation 210 for target cell (e.g. in target cell configuration corresponding to cell from which UE is switching to this target cell) (and sidelink communication configuration is included in target cell configuration):
   Do not set the NDIs for all HARQ process IDs to the value 0 for monitoring PDCCH in Sidelink resource allocation mode 1
   Do not cancel, if any, triggered Sidelink Buffer Status Reporting procedure;
   Do not initialize SBj for each logical channel to zero if Sidelink resource allocation mode 1 is configured by RRC;
Else:
   sets the NDIs for all HARQ process IDs to the value 0 for monitoring PDCCH in Sidelink resource allocation mode 1
   cancel, if any, triggered Sidelink Buffer Status Reporting procedure;
   initialize SBj for each logical channel to zero if Sidelink resource allocation mode 1 is configured by RRC;
cancel, if any, triggered configured sidelink grant confirmation
reset all SL_LBT_COUNTERs.

Partial MAC reset indicator is common for SL and non SL in this operation.

### Example 3

(Alternate) Upon receiving the L1 or L2 cell change/switch command (MAC CE or DCI) for a target cell (SpCell), UE perform the following operation:
If SLHARQContinue is indicated in the operation 205 and the operation 210 for target cell (e.g. in target cell configuration corresponding to cell from which UE is switching to this target cell) (and sidelink communication configuration is included in target cell configuration):
   Do not set the NDIs for all HARQ process IDs to the value 0 for monitoring PDCCH in Sidelink resource allocation mode 1
Else:
   sets the NDIs for all HARQ process IDs to the value 0 for monitoring PDCCH in Sidelink resource allocation mode 1
If SLBSRContinue is indicated in the operation 205 and the operation 210 for target cell (e.g. in target cell configuration corresponding to cell from which UE is switching to this target cell) (and sidelink communication configuration is included in target cell configuration):
   Do not cancel, if any, triggered Sidelink Buffer Status Reporting procedure;
Else:
   cancel, if any, triggered Sidelink Buffer Status Reporting procedure;
If SLSBContinue is indicated in the operation 205 and the operation 210 for target cell (e.g. in target cell configuration corresponding to cell from which UE is switching to this target cell) (and sidelink communication configuration is included in target cell configuration):
   Do not initialize SBj for each logical channel to zero if Sidelink resource allocation mode 1 is configured by RRC;
Else:
   initialize SBj for each logical channel to zero if Sidelink resource allocation mode 1 is configured by RRC;
cancel, if any, triggered configured sidelink grant confirmation
reset all SL_LBT_COUNTERs.

FIG. 4 is a block diagram of a terminal according to an embodiment of the disclosure.

Referring to FIG. 4, a terminal includes a transceiver 410, a controller 420 and a memory 430. The controller 420 may refer to a circuitry, an application-specific integrated circuit (ASIC), or at least one processor. The transceiver 410, the controller 420 and the memory 430 are configured to perform the operations of the UE illustrated in the figures, e.g., FIGS. 1 to 3, or described above. Although the transceiver 410, the controller 420 and the memory 430 are shown as separate entities, they may be realized as a single entity like a single chip. Or, the transceiver 410, the controller 420 and the memory 430 may be electrically connected to or coupled with each other.

The transceiver 410 may transmit and receive signals to and from other network entities (e.g., a base station or another terminal).

The controller 420 may control the UE to perform functions according to one of the embodiments described above.

In an embodiment, the operations of the terminal may be implemented using the memory 430 storing corresponding program codes. Specifically, the terminal may be equipped with the memory 430 to store program codes implementing desired operations. To perform the desired operations, the controller 420 may read and execute the program codes stored in the memory 430 by using a processor or a central processing unit (CPU).

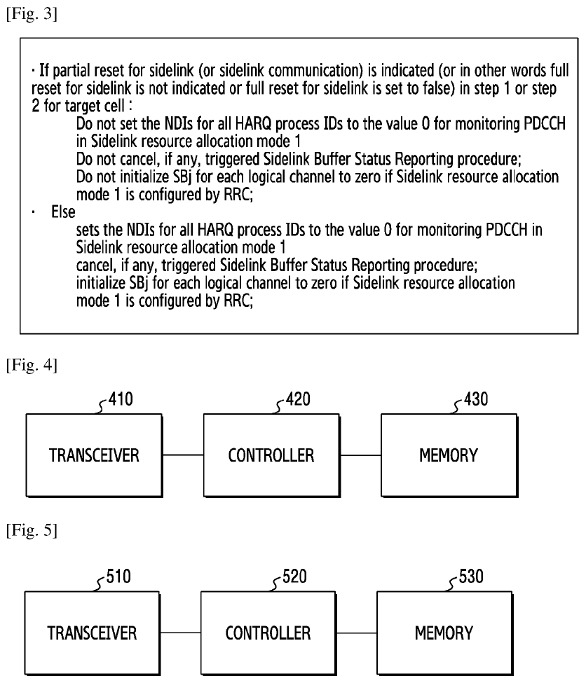

FIG. 5 is a block diagram of a base station according to an embodiment of the disclosure.

Referring to FIG. 5, a base station includes a transceiver 510, a controller 520 and a memory 530. The transceiver 510, the controller 520 and the memory 530 are configured to perform the operations of the network (e.g., gNB) illustrated in the figures, e.g., FIGS. 1 to 3, or described above. Although the transceiver 510, the controller 520 and the memory 530 are shown as separate entities, they may be realized as a single entity like a single chip. The transceiver 510, the controller 520 and the memory 530 may be electrically connected to or coupled with each other.

The transceiver 510 may transmit and receive signals to and from other network entities, e.g., a terminal. The controller 520 may control the base station to perform functions according to one of the embodiments described above. The controller 520 may refer to a circuitry, an ASIC, or at least one processor. In an embodiment, the operations of the base station may be implemented using the memory 530 storing corresponding program codes. Specifically, the base station may be equipped with the memory 530 to store program codes implementing desired operations. To perform the desired operations, the controller 520 may read and execute the program codes stored in the memory 530 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1. A method performed by a terminal in a wireless communication system, the method comprising:
receiving, from a source base station, a first message including configuration information for a candidate target base station;
transmitting, to the source base station, a second message including an L1 measurement report for the candidate target base station;
receiving, from the source base station, a cell switch command to the candidate target base station; and
identifying whether a partial reset for a sidelink communication is indicated in the configuration information for the candidate target base station.

2. The method of claim 1, wherein, in case that the partial reset for the sidelink communication is indicated in the configuration information, the method further comprises performing at least one of:
not setting a new data indicator (NDI) for all hybrid automatic repeat request (HARQ) identifiers (IDs) to a value of 0 in a sidelink resource allocation mode 1;
not cancelling a triggered sidelink buffer status reporting; or
not initializing an SBj for a logical channel to 0 in case that the sidelink resource allocation mode 1 is configured.

3. The method of claim 1, wherein, in case that a full reset for the sidelink communication is not indicated in the configuration information, the method further comprises performing at least one of:
not setting an NDI for all HARQ IDs to a value of 0 in a sidelink resource allocation mode 1;
not cancelling a triggered sidelink buffer status reporting; or
not initializing an SBj for a logical channel to 0 in case that the sidelink resource allocation mode 1 is configured.

4. The method of claim 1, wherein, in case that a full reset for the sidelink communication is set to false in the configuration information, the method further comprises performing at least one of:
not setting an NDI for all HARQ IDs to a value of 0 in a sidelink resource allocation mode 1;
not cancelling a triggered sidelink buffer status reporting; or
not initializing an SBj for a logical channel to 0 in case that the sidelink resource allocation mode 1 is configured.

5. The method of claim 1, further comprising:
performing a sidelink HARQ retransmission to the candidate target base station according to the cell switch command, based on the identification; and
performing the triggered sidelink buffer status reporting based on the identification.

6. The method of claim 1, wherein, in case that the partial reset for the sidelink communication is not indicated in the configuration information or a full reset is indicated in the configuration information, or the full reset is set to true in the configuration information, the method further comprises performing at least one of:
setting an NDI for all HARQ IDs to a value of 0 in a sidelink resource allocation mode 1;
cancelling a triggered sidelink buffer status reporting; or
initializing an SBj for a logical channel to 0 in case that the sidelink resource allocation mode 1 is configured.

7. The method of claim 1, wherein the source base station includes a source distributed unit (DU) and a central unit (CU), and the candidate target base station includes a target DU and the CU, and
wherein the configuration information is delivered from the target DU via the CU to the source DU.

8. A terminal in a wireless communication system, the terminal comprising:
a transceiver; and
a controller coupled with the transceiver and configured to:
receive, from a source base station, a first message including configuration information for a candidate target base station,
transmit, to the source base station, a second message including an L1 measurement report for the candidate target base station,
receive, from the source base station, a cell switch command to the candidate target base station, and
identify whether a partial reset for a sidelink communication is indicated in the configuration information for the candidate target base station.

9. The terminal of claim 8, wherein, in case that the partial reset for the sidelink communication is indicated in the configuration information, the controller is further configured to perform at least one of:
not setting a new data indicator (NDI) for all hybrid automatic repeat request (HARQ) identifiers (IDs) to a value of 0 in a sidelink resource allocation mode 1;
not cancelling a triggered sidelink buffer status reporting; or
not initializing an SBj for a logical channel to 0 in case that the sidelink resource allocation mode 1 is configured.

10. The terminal of claim 8, wherein, in case that a full reset for the sidelink communication is not indicated in the configuration information, the controller is further configured to perform at least one of:
not setting an NDI for all HARQ IDs to a value of 0 in a sidelink resource allocation mode 1;
not cancelling a triggered sidelink buffer status reporting; or
not initializing an SBj for a logical channel to 0 in case that the sidelink resource allocation mode 1 is configured.

11. The terminal of claim 8, wherein, in case that a full reset for the sidelink communication is set to false in the configuration information, the controller is further configured to perform at least one of:
not setting an NDI for all HARQ IDs to a value of 0 in a sidelink resource allocation mode 1;
not cancelling a triggered sidelink buffer status reporting; or
not initializing an SBj for a logical channel to 0 in case that the sidelink resource allocation mode 1 is configured.

12. The terminal of claim 8, wherein the controller is further configured to:
perform a sidelink HARQ retransmission to the candidate target base station according to the cell switch command, based on the identification.

13. The terminal of claim 8, wherein the controller is further configured to:
perform the triggered sidelink buffer status reporting based on the identification.

14. The terminal of claim 8, wherein, in case that the partial reset for the sidelink communication is not indicated in the configuration information or a full reset is indicated in the configuration information, or the full reset is set to true in the configuration information, the controller is further configured to perform at least one of:
setting an NDI for all HARQ IDs to a value of 0 in a sidelink resource allocation mode 1;
cancelling a triggered sidelink buffer status reporting; or
initializing an SBj for a logical channel to 0 in case that the sidelink resource allocation mode 1 is configured.

15. The terminal of claim 8, wherein the source base station includes a source distributed unit (DU) and a central unit (CU), and the candidate target base station includes a target DU and the CU, and
wherein the configuration information is delivered from the target DU via the CU to the source DU.
